(19) United States
(12) Patent Application Publication
(10) Pub. No.: US 2006/0243004 A1
(43) Pub. Date: Nov. 2, 2006

(54) Self-locking strap assembly

(76) Inventors: Stephen W. Johnson, Columbia Heights, MN (US); Christopher J. Voges, Eden Prairie, MN (US); Timothy D. Callahan, Minneapolis, MN (US); Jason A. Doolittle, Shoreview, MN (US)

Correspondence Address: SMITH LAW OFFICE, 440 SCIENCE DR., SUITE 302, MADISON, WI, 53711, US

(21) Appl. No.: 11/477,254

(22) Filed: Jun. 29, 2006

Related U.S. Application Data
(62) Division of application No. 10/756,816, filed on Jan. 13, 2004, now abandoned.
(60) Provisional application No. 60/439,789, filed on Jan. 13, 2003.

(51) Int. Cl. E05B 75/00

(52) U.S. Cl. 70/16

(57) ABSTRACT

The present invention relates to a self-locking strap assembly. The assembly includes a buckle having an outer concave surface and a passageway. A strap is secured to the buckle at a first position and is adapted to be inserted into the passageway at a second position. A retainer is coupled to the buckle and adapted to engage the strap such that movement in one direction of the strap in the passageway relative to the buckle is inhibited.

The application is a divisional of application Ser. No. 10/756,816, filed Jan. 13, 2004, the disclosure of which is incorporated by reference herein.

### BACKGROUND OF THE INVENTION

The present invention relates to a self-locking strap assembly. In particular, the present invention relates to strap assemblies for restraining individuals, such as disposable handcuffs.

Disposable handcuffs are used by police officers, security guards and the like for temporarily restraining individuals. Disposable handcuffs, due to their size and weight, are useful in various circumstances including multiple arrest situations and prisoner transfers. Additionally, disposable handcuffs can be made out of a plastic material which prevents the activation of metal detectors in airports, courthouses, prisons and other protected structures.

Current disposable handcuffs are close variations to a traditional cable tie. Generally, a cable tie is made of a hard plastic material that includes an elongated strap and a locking head. Upon insertion of the elongated strap within the locking head, the locking head includes teeth to prevent withdrawal of the strap such that an individual cannot release the strap from the locking head. One drawback of using cable tie arrangements as a restraining device is that the arrangements can cause excessive damage to a person's wrist during restraint. The hard, plastic material of the elongated strap and locking head can cut into and otherwise damage a person's wrist. Thus, a self-locking strap assembly is needed that provides adequate restraint of individuals while preventing excessive damage to a person's wrist during restraint.

### SUMMARY OF THE INVENTION

The present invention relates to a self-locking strap assembly. In one aspect, the assembly includes a buckle having an outer concave surface and a passageway. A strap is secured to the buckle at a first position and is adapted to be inserted into the passageway at a second position. A retainer is coupled to the buckle and adapted to engage the strap such that movement in one direction of the strap in the passageway relative to the buckle is inhibited.

### BRIEF DESCRIPTION OF THE DRAWINGS

FIG. 1 is a top isometric view of a strap assembly.

FIG. 2 is a bottom isometric view of a strap assembly.

FIG. 3 is a side view of a strap assembly.

FIG. 4 is a top view of a strap assembly.

FIG. 5 is a side view of a strap assembly.

FIG. 6 is a top isometric view of a housing element.

FIG. 7 is a top view of a housing element.

FIG. 8 is a side view of a housing element.

FIG. 9 is a top isometric view of a housing element.

FIG. 10 is a top view of a housing element.

FIG. 11 is a side view of a housing element.

FIG. 12 is a top isometric view of a retainer.

FIG. 13 is a top isometric view of a strap.

FIG. 14 a top isometric view of a separator.

FIG. 15 is an alternative embodiment of an assembly.

### DESCRIPTION OF THE PREFERRED EMBODIMENTS

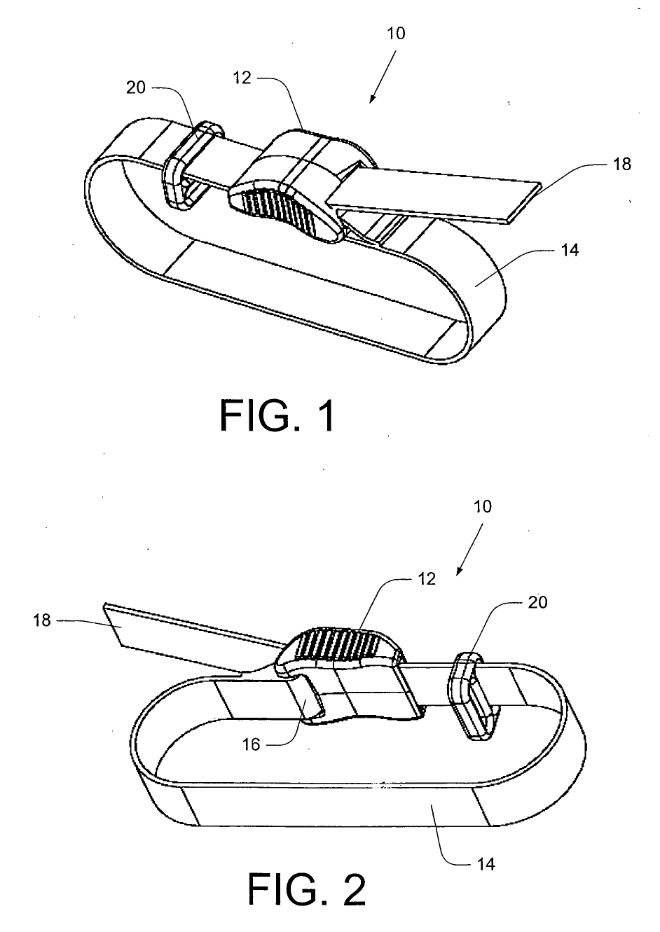

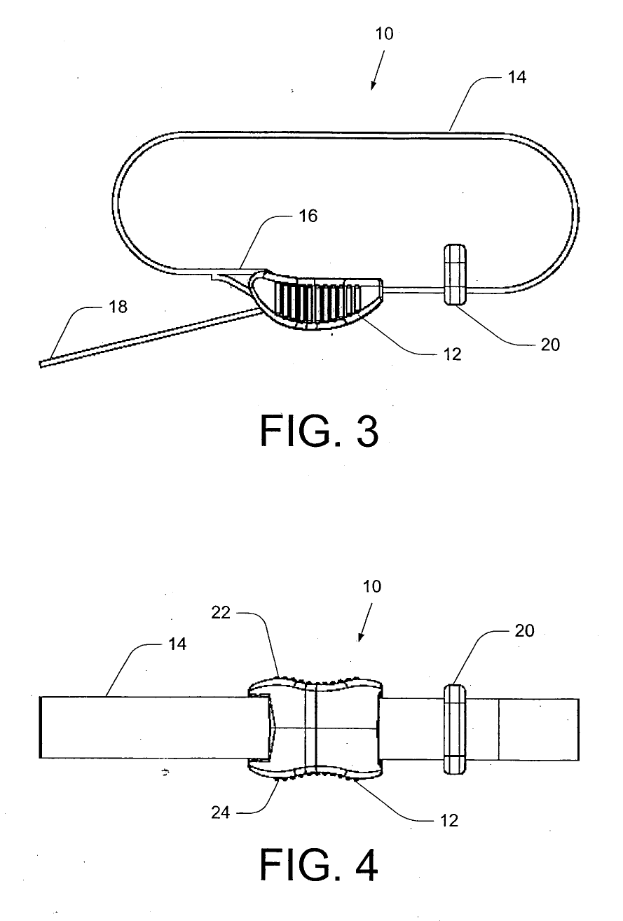

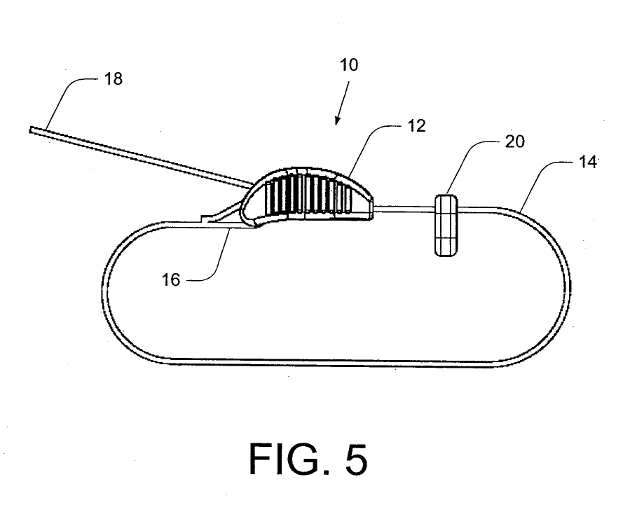

FIGS. 1-5 illustrate an embodiment of the present invention. Assembly 10 includes a buckle 12 that is curved on one surface to engage a person's body such as a wrist or ankle, while a soft strap 14 wraps around a person's wrist and is secured at the buckle 12 near both ends. One end of the soft strap 14 can be permanently secured to the buckle 12, while the other end of the strap 14 passes through the buckle 12 and is held by a retainer that engages the strap 14. In the embodiment illustrated, strap 14 includes a first end 16 having a loop secured to one end of the buckle 12. A free end 18 of strap 14 is inserted into a passageway in buckle 12, where a retainer, described below, engages the strap 14 through the passageway in one direction. If desired, a separator 20 can be used to form multiple loops in strap 14 before inserting free end 18 into buckle 12.

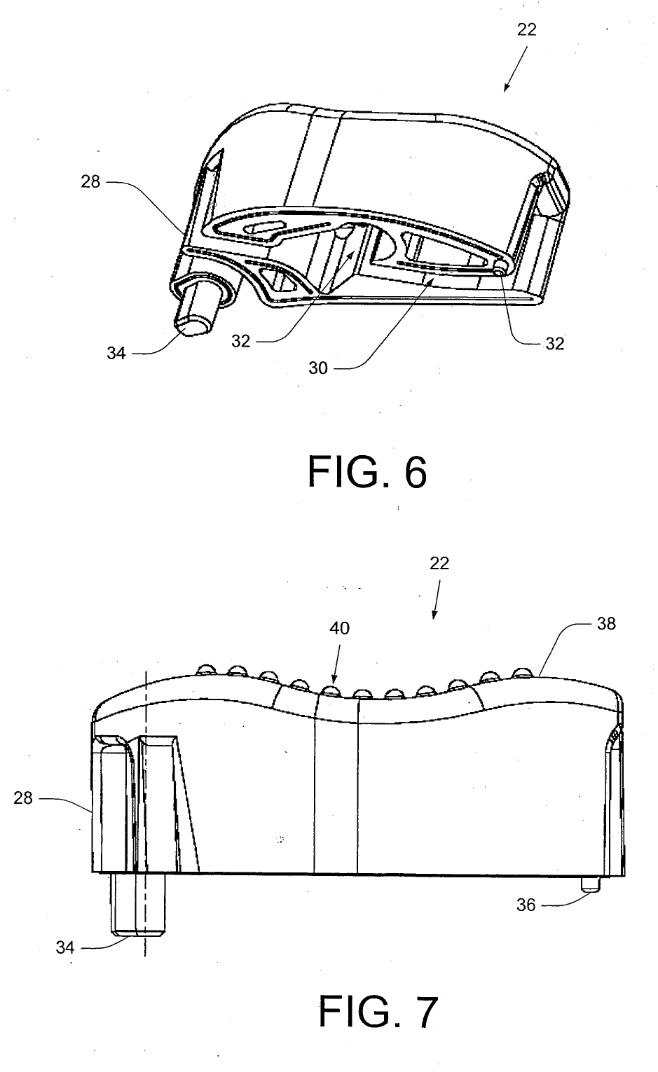

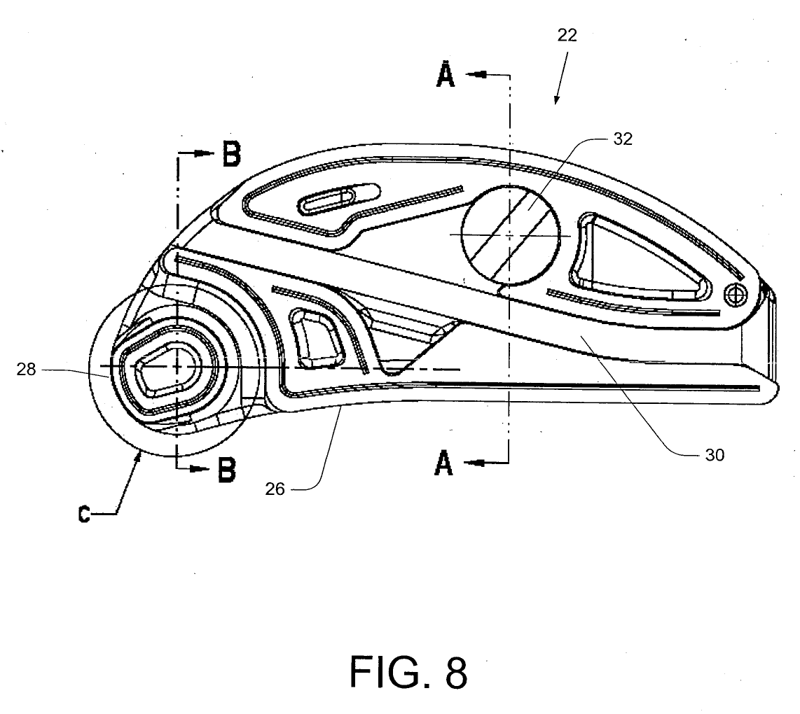

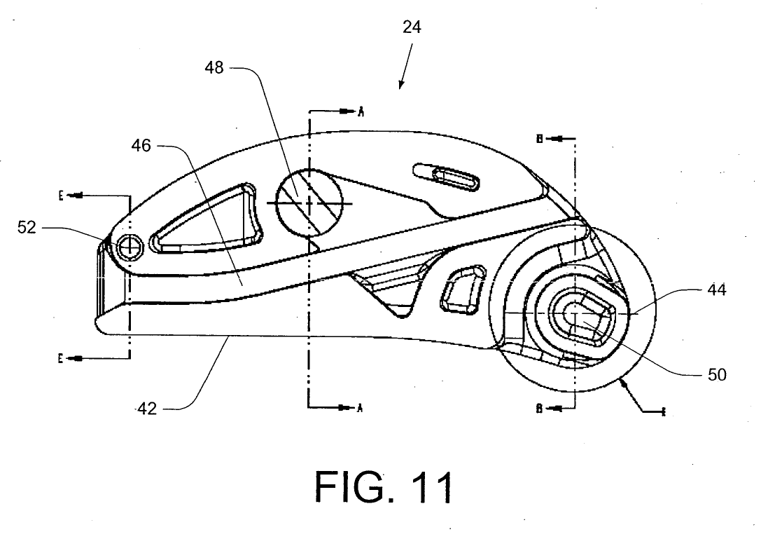

With further reference to FIGS. 6-11, buckle 12 can be formed from a two-part housing including a first housing element 22 and a second housing element 24. In one embodiment, buckle 12 can be made of a plastic material. As illustrated in FIGS. 6-8, housing element 22 includes a lower concave surface 26. The lower concave surface 26 is adapted to engage a person's wrist or ankle in order to minimize injury during restraint. Additionally, housing element 22 further includes a shaft 28 that receives the loop of first end 16 of strap 14 and a passageway 30 to receive free end 18 of strap 14. A cavity 32 within housing element 22 can receive a suitable retainer, described below, for engaging strap 14 to prevent movement of free end 18 back through passageway 30 after insertion. Housing element 22 also includes a first pin 34 and a second pin 36 for engaging and securing housing element 22 to housing element 24. In order to aid an operator in grasping buckle 12 and pulling strap 14 to engage the retainer, housing element 22 includes a concave side wall 38 and a plurality of ribs 40.

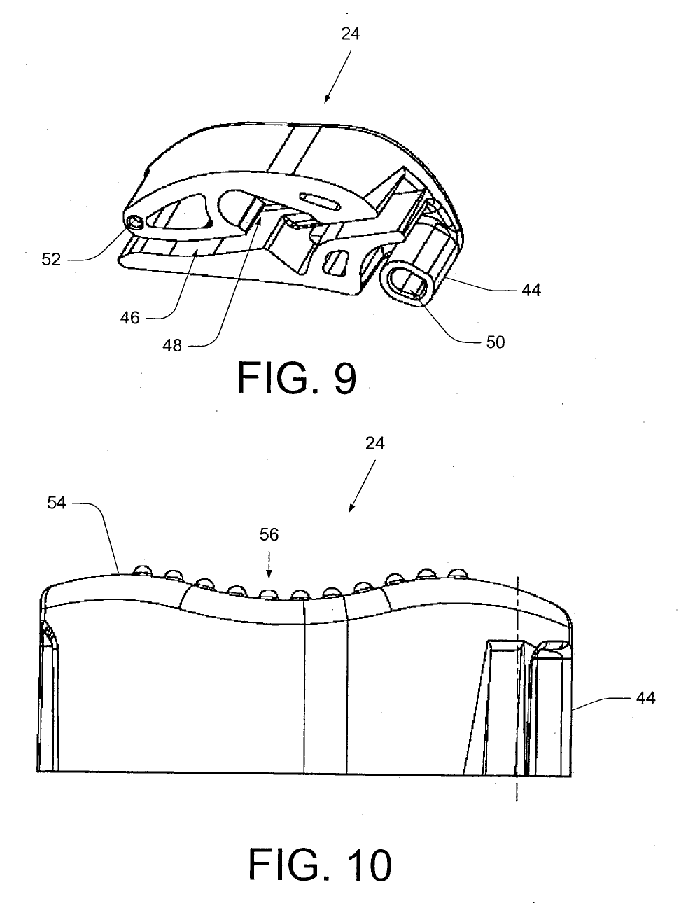

With reference to FIGS. 9-11, housing element 24 includes a lower concave surface 42 similar to lower concave 26 of housing element 22. The lower concave surface 42 is adapted to engage a person's wrist or ankle in order to minimize injury during restraint. Housing element 24 also includes a shaft 44 that receives the loop of first end 16 of strap 14 and a passageway 46 to receive free end 18 of strap 14. A cavity 48, which is aligned with cavity 32 of housing element 22, receives a retainer for engaging strap 14 to prevent movement of free end 18 back through passageway 46 after insertion. Housing element also includes a first aperture 50 and a second aperture 52 for receiving first pin 34 and second pin 36 of housing element 22, respectively. Similar to housing element 22, in order to aid an operator in grasping buckle 12 and pulling strap 14 to engage the retainer, housing element 24 includes a concave side wall 54 and a plurality of ribs 56.

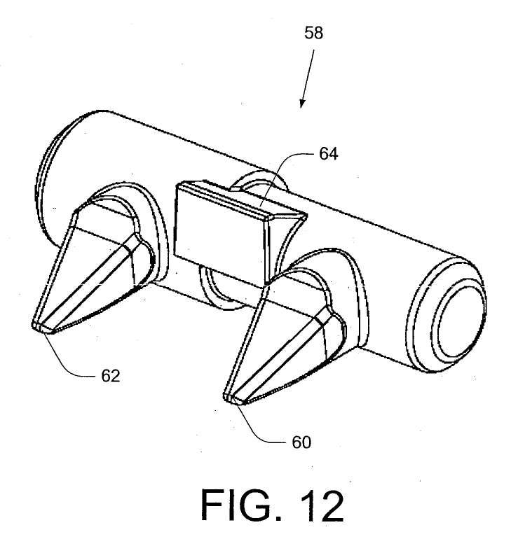

FIG. 12 illustrates a retainer 58 that is housed by buckle 12 in cavities 32 and 48. Retainer 58 can be made out of a plastic or other suitable material in accordance with the present invention. Retainer 58 includes a first pointed barb 60 and a second pointed barb 62. Retainer 58 is slightly pivotable in cavities 32 and 48 to allow strap 14 to slide through passageways 30 and 46. Movement of the strap 14 in an opposite direction causes the pointed ends of barbs 60 and 62 to engage strap 14, which inhibits further movement of the strap 14 in the reverse direction. Retainer 58 can also include an over travel stop 64 that limits rotation of retainer 58 within cavities 32 and 48.

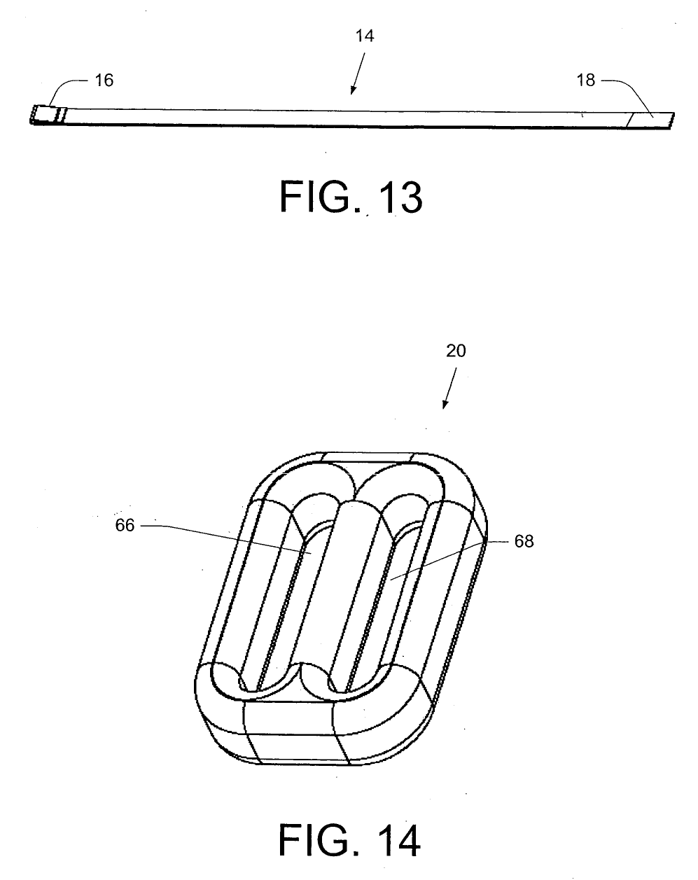

FIG. 13 illustrates strap 14 including first end 16 and second end 18. As discussed above, first end 16 includes a loop that is received by buckle 12 that can be sewn or heat staked to form the loop. In accordance with a further aspect of the present invention, second end 18 may be heat staked. Heat staking a portion of second end 18 allows end 18 to be inserted partially into buckle 12 and subsequently removed. The heat staked portion of end 18 is prevented from being engaged by barbs 60 and 62 of retainer 58 and also provides a stiffer portion to be inserted into passageways 30 and 46. In addition, strap 14 has a width substantially greater than its thickness so as to be flexible and increase the surface area of contact with a person's wrist in order to minimize injury thereto and allow the strap to be folded over for easier packaging and carrying of assembly 10. Suitable materials that can be used for strap 14 include nylon and woven polypropylene.

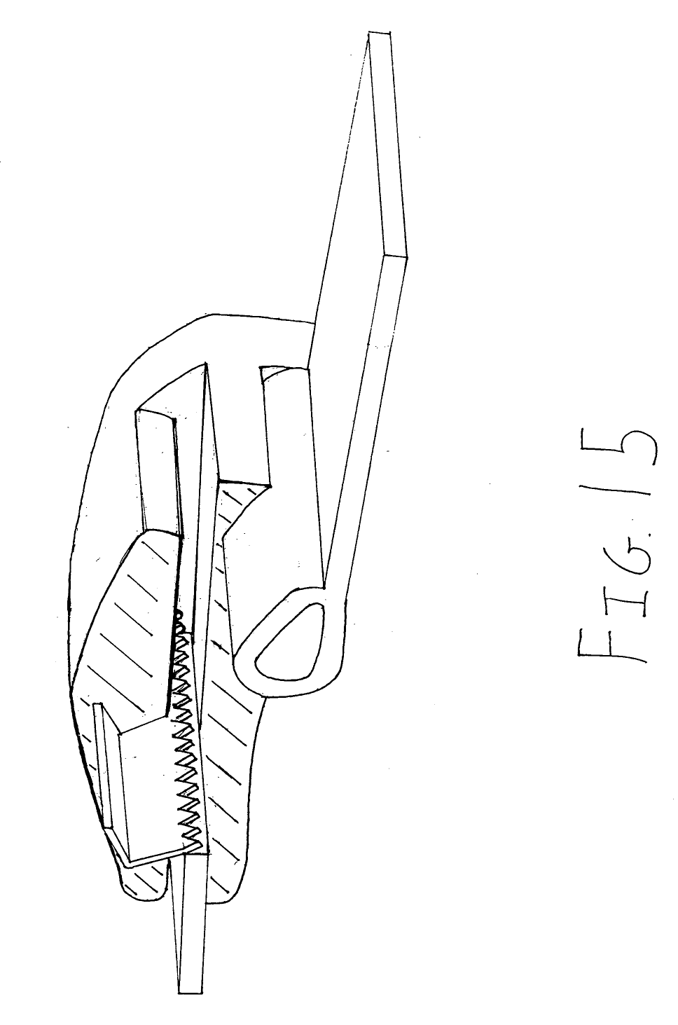

FIG. 14 illustrates an isometric view of separator 20. Separator 20 includes apertures 66 and 68 for receiving strap 14. Using aperture 66 and 68, multiple loops within strap 14 can be formed by inserting strap 14 into each of the apertures 66 and 68. For example, one loop can be used to secure a first wrist of an individual and one loop can be used to secure a second wrist of the individual. Additionally, multiple assemblies 10 can be looped together using multiple loops in each of the straps 14 of the assemblies 10.

As appreciated by those skilled in the art, other variations of the embodiment described above can be used in accordance with the present invention. For example, FIG. 15 illustrates an alternative embodiment of an assembly 70 including a buckle 72, strap 74 and retainer 76. In this embodiment, the retainer 76 is a metal, serrated blade including a plurality of teeth to engage strap 14 upon insertion into buckle 72.

Although the present invention has been described with reference to preferred embodiments, workers skilled in the art will recognize that changes may be made in form and detail without departing from the spirit and scope of the invention.

1. A method of securing limbs of a person comprising:
providing a buckle having an outer concave surface, a cavity and a passageway;
providing a strap having a first end secured to the buckle and a second end configured to be inserted into the passageway; and
providing a retainer positioned in the cavity such that the buckle covers the retainer and the cavity limits movement with respect to the buckle and wherein the retainer is adapted to engage the strap to inhibit movement of the strap in one direction relative to the buckle.

2. The method of claim 1, further comprising:
providing a separator having a first and a second aperture configured to receive the strap.

3. The method of claim 2, further comprising:
inserting the second end of the strap into the first and the second apertures before the passageway.
